(19) United States
(12) Patent Application Publication
(10) Pub. No.: US 2023/0267452 A1
(43) Pub. Date: Aug. 24, 2023

(54) SYSTEMS AND METHODS FOR AUTOMATIC DIGITAL ASSET TRANSFER

(71) Applicant: Webacy, Inc., San Francisco, CA (US)

(72) Inventors: Maika Isogawa, San Francisco, CA (US); Brian Tek Fung Wong, New York, NY (US)

(21) Appl. No.: 18/173,732

(22) Filed: Feb. 23, 2023

Related U.S. Application Data
(60) Provisional application No. 63/312,967, filed on Feb. 23, 2022.

(51) Int. Cl. G06Q 20/36

(52) U.S. Cl. CPC G06Q 20/3678; G06Q 2220/00

(57) ABSTRACT

Methods and systems for automated digital asset transfer are provided. In one aspect, the method can include receiving, by a user interface, configuration parameters comprising an indication of a user wallet address and an indication of a beneficiary wallet address, wherein the user wallet address and the beneficiary wallet address correspond to a blockchain, wherein the user wallet address comprises one or more digital assets. The method can include causing generation, based on the configuration parameters, of a smart contract configured to transfer the one or more digital assets from the user wallet address to the beneficiary wallet address based on a time period of inactivity at the user wallet address. When the time period of inactivity exceeds a threshold time period, the smart contract can be configured to transfer the one or more digital assets from the user wallet address to the beneficiary wallet address.

### CROSS REFERENCE TO RELATED APPLICATIONS

This application claims the benefit of and priority to U.S. Provisional Application No. 63/312,967, filed on Feb. 23, 2022, entitled “SYSTEMS AND METHODS FOR AUTOMATIC DIGITAL ASSET TRANSFER,” which is hereby incorporated by reference herein in its entirety.

### TECHNICAL FIELD

The following disclosure is directed to methods and systems for digital asset transfer, more specifically, methods and systems for automatic, custodian-free transfer of digital assets between entities using smart contracts embedded in a blockchain network.

### BACKGROUND

Digital assets (e.g., cryptocurrencies and other crypto-assets recorded on a blockchain) may be accessed via a “wallet”, where the wallet includes public and private key information used to manage the digital assets and transfer the digital assets between entities. Conventional processes for transferring digital assets between entities involve use of the owner (i.e. sender) entity's private key that corresponds to their respective wallet. To transfer digital assets, an owner entity can initiate a transaction to send digital assets from the owner entity's wallet to the beneficiary (i.e. receiver) entity's wallet using the owner entity's private key. After sending the transaction to a blockchain network (e.g., decentralized peer-to-peer network of computing devices), validator nodes on the blockchain network can validate the transaction and append the transaction to the blockchain, resulting in recordation and transfer of the digital assets on the blockchain between the owner entity and beneficiary entity. However, there may be instances where a beneficiary entity is granted permission to receive digital assets from an owner entity (e.g., in a contract and/or any other legal grant), but the owner entity's private key is inaccessible and/or otherwise unavailable to enable such a transfer. In these instances, a beneficiary entity can be left without options to receive and access the digital assets to which they have been granted ownership. For example, a will may legally assign an owner's digital assets to a beneficiary in the event of the death of the owner, but if the will does not include access to the necessary private key(s) needed to access the digital assets, the beneficiary may be unable to access their assigned digital assets.

Further, smart contracts (e.g., computer programs and/or transaction protocols) have been developed for use with blockchain networks, where a smart contract includes computer code and data. A smart contract (including its functions and state) can be added to a blockchain network and can automatically execute according to its included computer code based on its rules and conditions being met. In some cases, transaction request on the blockchain network may interact with the smart contract to execute functions included in the smart contract. Decentralized applications (referred to as “dApps”) have been developed for blockchain networks that may combine a smart contract and/or other computer code operating on a blockchain network with a front-end user interface operating on a non-blockchain computing network to enable improved interaction with the smart contract.

Accordingly, there is a need for systems and methods that can automate the transfer of digital assets in the event that a private key corresponding to the digital assets is unavailable and/or in an event that is based on contractually agreed conditions. Such systems and methods may employ smart contracts and/or dApps operating in a blockchain network to automate the transfer of digital assets based on any number of conditions, including for example, a loss of a private key and/or password corresponding to digital assets.

### SUMMARY

Disclosed herein are methods and systems for automatic transfer of digital assets between an owner entity and a beneficiary entity using smart contracts embedded in a blockchain network. In one aspect, the subject matter described herein relates to a computer-implemented method for digital asset transfer. The method can include receiving, by a user interface, configuration parameters comprising an indication of a user wallet address and an indication of a beneficiary wallet address, where the user wallet address and the beneficiary wallet address correspond to a blockchain, where the user wallet address comprises one or more digital assets. The method can include causing generation, based on the configuration parameters, of a smart contract configured to transfer the one or more digital assets from the user wallet address to the beneficiary wallet address based on a time period of inactivity at the user wallet address.

Various embodiments of the method can include one or more of the following features. The digital assets can include at least one of a cryptocurrency token and/or a non-fungible token. The method can include receiving, by the user interface, a first input configured to cause generation of the smart contract. The causing generation of the smart contract can further include: sending, to a decentralized application operating on the blockchain, instructions to generate the smart contract, where the instructions comprise the configuration parameters, and where the decentralized application is configured to (i) generate the smart contract; and (ii) send the smart contract to the blockchain. The method can include sending the configuration parameters to a remote procedure calls (RPC) node, where the RPC node is configured to cause generation of the smart contract based on receiving a second input. The smart contract can be configured to identify wallet activity at the user wallet address. The time period of inactivity at the user wallet address can include a duration for which the smart contract has not identified the wallet activity at the user wallet address.

In some embodiments, the wallet activity can include: signing, by the user wallet address, a transaction; sending, by the user wallet address a transaction request to the blockchain network; sending, by user wallet address, digital assets; and/or assigning, by the user wallet address, delegate permissions. Based on identifying the wallet activity, the smart contract is configured to set the time period of inactivity to zero seconds. When the time period of inactivity at the user wallet address exceeds a threshold time period, the smart contract can be configured to transfer the one or more digital assets from the user wallet address to the beneficiary wallet address. The method can include receiving, by the user interface, a third input comprising an indication to claim the one or more digital assets at the beneficiary wallet address, where the smart contract is configured to transfer the one or more digital assets from the user wallet address to the beneficiary wallet address based on the indication. The method can include identifying a security event associated with a credential for the user interface, where the credential is associated with the user wallet address, where the smart contract is configured to transfer the one or more digital assets from the user wallet address to the beneficiary wallet address based on the security event. The method can include receiving, by the user interface, a fourth input comprising an indication to revoke the smart contract from the blockchain; and sending, to the blockchain, second instructions to revoke the smart contract.

Other aspects of the invention comprise systems implemented in various combinations of computing hardware and software to achieve the methods described herein.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from the foregoing and the following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 depicts a block diagram of an exemplary system for digital asset transfer, according to some embodiments.

FIG. 2 depicts a flowchart of an exemplary method for digital asset transfer, according to some embodiments;

FIG. 3 is a block diagram of an example computer system that may be used in implementing the technology described herein.

FIG. 4 is an exemplary system diagram illustrating a blockchain, according to some embodiments.

FIG. 5 shows an exemplary system diagram of nodes associated with a blockchain and storing the ledger of the blockchain, according to some embodiments.

FIG. 6 is an exemplary system diagram illustrating validator nodes associated with a blockchain, according to some embodiments.

FIG. 7 is a diagram illustrating an exemplary smart contract, according to some embodiments.

### DETAILED DESCRIPTION

The present disclosure is directed to systems and methods for automatic transfer of digital assets between an owner entity and a beneficiary entity using smart contracts embedded in a blockchain network. Automatic transfer of digital assets may be occur based on one or more conditions including, for example, loss of access to a wallet due to inactivity of an owner of the digital assets. Loss of access to a wallet corresponding to the digital assets may result from death of the owner, incapacitation of the owner, and/or loss of private key(s) corresponding to the wallet and digital assets. The systems and methods described herein may be adapted for additional use cases. Some non-limiting examples of additional use cases for the systems and methods described herein include automatic digital asset transfer according to peer-to-peer agreements (e.g., prenuptial agreements), corporate agreements between individuals and/or entities, the creation of a digital testamentary trust (e.g., crypto) asset wallet or similar instrument, release of funds for a pre-defined use case for children passing a certain age, and/or security events (e.g., a security breach).

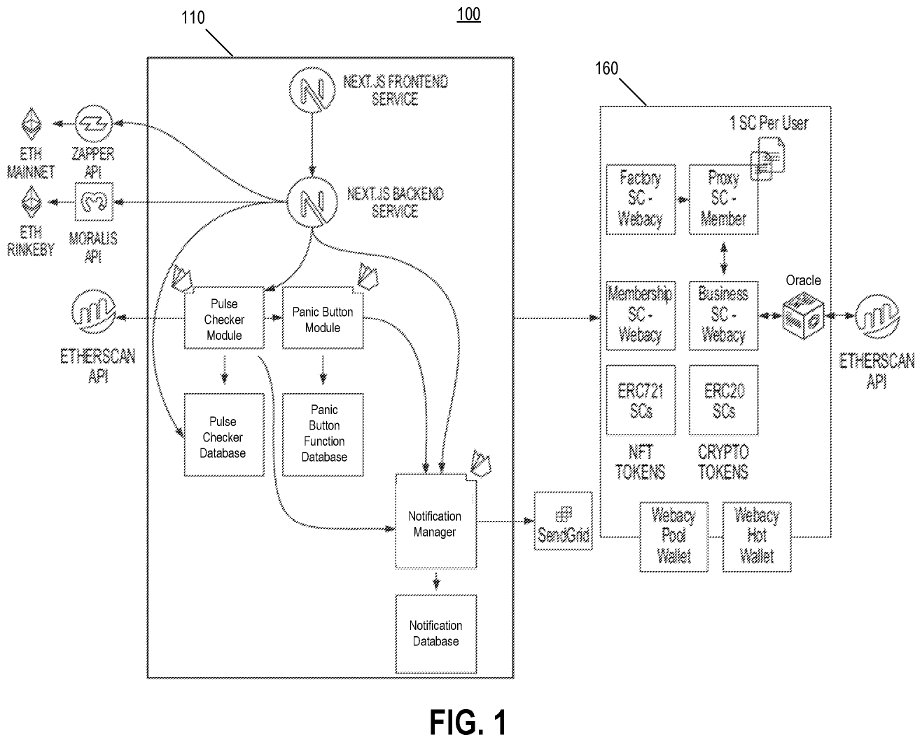

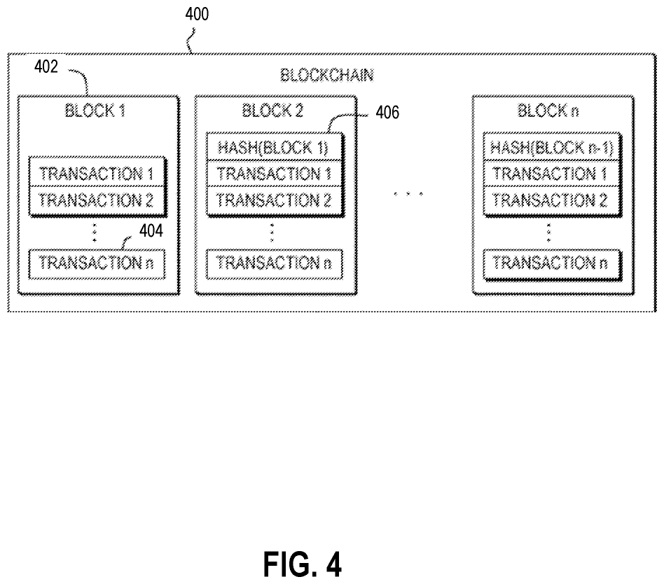

A digital asset transfer system and method as described herein may perform automatic transfer of a user's (i.e. owner entity's) digital assets corresponding to one or more wallets to a selected beneficiary wallet address and/or a group of beneficiary wallet addresses. FIG. 1 depicts a block diagram of a digital asset transfer system 100, according to some embodiments. The digital asset transfer system 100 may include one or more blockchain network elements (referred to as “on-chain” elements 160) including, for example, smart contracts and/or dApps configured to interface with a blockchain network. An example of a blockchain network configured to interface with the digital asset transfer system 100 includes an Ethereum blockchain (e.g., blockchain 400 as described with respect to FIG. 4), as well as any other blockchain network configured to operate with smart contracts and/or dApps. In some cases, the on-chain components 160 may include an oracle (e.g., a Chainlink oracle) configured to enable communication between on-chain components 160 (e.g., including smart contracts and wallets) with off-chain components as described herein via an API. The on-chain components may be include factory smart contracts, proxy smart contracts, membership smart contracts, business smart contracts, smart contracts configured to generate NFT tokens, and/or smart contracts configured to cause transfer of other cryptocurrency tokens (e.g., Bitcoin, Ether, etc.). The on-chain components may include a number of digital wallets, such as a pool wallet and/or a hot wallet corresponding to an administrator of the digital asset transfer system 100.

In some embodiments, the digital asset transfer system 100 may include one or more components (referred to as “off-chain” components 110) configured to execute and/or operate on computing devices (e.g., client devices and/or servers) that are external to the blockchain network. For example, a user may access a user interface at the digital asset transfer system 100 via a web browser or application operating on a client computing device, where the off-chain components 110 of the digital asset transfer system 100 are hosted at one or more remote servers. In some cases, the off-chain components 110 may be hosted by a cloud computing system. The off-chain components 110 may include a front end service and a back end service. The off-chain components 110 may include a pulse checker module, pulse checker database, panic button module, panic button database, notification manager, and notification database. In some cases, the off-chain components may be communicatively connected as shown in FIG. 1.

In some embodiments, on-chain components 160 and off-chain components 110 of the digital asset transfer system 100 may communicate and/or interface via one or more application programming interfaces (APIs). Some non-limiting examples of APIs used to communicate between on-chain components 160 and off-chain components 110 can include a Zapper API, Moralis API, and Etherscan API as shown in FIG. 1. A Zapper API and a Moralis API can be configured to identify and/or visually showcase mainnet (e.g., production, globally deployed blockchain) assets in a particular wallet and testnet assets in a wallet (e.g., staging environment designed for development purposes). As an example, a user interface of the digital asset transfer system 100 may display indications of mainnet and testnet assets stored in wallets of the on-chain components 160. Any suitable API (or other system) may be used to receive and/or retrieve information indicative of mainnet assets and/or testnet assets of one or more wallets. In some cases, the digital asset transfer system 100 may interface and/or communicate with one or more third-party services and/or applications.

In some embodiments, the digital asset transfer system 100 may interface with one or more third-party services and/or applications via one or more APIs (e.g., as shown in FIG. 1). An example of an API used by the digital asset transfer system 100 to interface and/or communicate with a third-party service and/or application may include a notification system API. An example of a notification system API may be a SendGrid API. One or more computing networks as described below may enable communications between off-chain components 110 of the digital asset transfer system 100, on-chain components 160 of the digital asset transfer system 100, APIs, third-party services and applications, and user computing devices.

In some embodiments, as a described herein, the digital asset transfer system 100 may include a user interface. The user interface may be included in a front end service of the off-chain components 110. The user interface may be accessible via a web browser or an application operating on a client (e.g., user) computing device. To access the digital asset transfer system 100, a user may create a credential using the user interface, where the credential may be used to authenticate the user's access to the digital asset transfer system 100. The credential may include one or more of a username, identifier, password, email address, and/or any other suitable set of characters used to identify and authenticate the user. In some cases, the digital asset transfer system 100 may not require a credential to function, such that users can use the digital asset transfer system 100 without a providing a credential. Via the user interface, a user may connect their wallet(s) to the digital asset transfer system 100. In some cases, an API (e.g., a wallet API) may be used to connect the user's wallets to the digital asset transfer system 100. An example of a wallet API may include a Zapper API. In some cases, a user may connect their respective wallet(s) to the digital asset transfer system 100 using a first-party wallet service. For some non-limiting examples of wallet services, a user may connect wallets comprising any suitable digital assets (e.g., including fungible and/or non-fungible tokens) to the digital asset transfer system 100. As an example, if the digital asset transfer system 100 is configured to interface with the Ethereum blockchain for the on-chain assets 160, a user may connect wallets including ERC-20, ERC-721, and/or ERC-1155 tokens. As described herein, any suitable blockchain and corresponding digital asset tokens may be used in accordance with the digital asset transfer system 100. Indications of digital assets included in user's digital wallets may be made available by the user interface of the digital asset transfer system 100. Examples of digital assets may include cryptocurrency tokens (e.g., Bitcoin, Ether, etc.), decentralized finance (DeFi) tokens, fungible tokens, and non-fungible tokens. To connect their wallet(s) to the digital asset transfer system 100, a user may be required to provide the public and/or private keys to the digital asset transfer system 100 (e.g., via the user interface).

In some embodiments, via the user interface, user may configure one or more beneficiaries of the user's digital assets. A user may configure the one or more beneficiaries of their digital assets based on (e.g., after) connecting one or more wallets to the digital asset transfer system 100. Beneficiaries may be specified via their respective wallet addresses. A user may enter wallet addresses corresponding to their selected beneficiaries via the user interface. In some cases, a user may configure one or more backup wallets for their digital assets, where the user may own and/or otherwise manage the one or more backup wallets. The backup wallets may be specified by their respective wallet addresses, such that the user's digital assets may be automatically transferred to the backup wallets based on conditions as described further below. Via the user interface, a user may configure a subset or all of their respective digital assets to be automatically transferred to any combination of the beneficiary wallets and/or backup wallets.

In some embodiments, a digital asset transfer system 100 may generate and/or instantiate one or more smart contracts. The digital asset transfer system 100 may instantiate smart contracts via a dApp. When a user initiates the dApp corresponding to and/or included in the digital asset transfer system 100 (e.g., via an input provided at the user interface), the dApp may cause generation of a smart contract and the smart contract may be signed to a blockchain network (e.g., such that the smart contract is validated and added to be included in the on-chain components 160). In some cases, based on providing an input to the user interface of the digital asset transfer system 100, the user may revoke the smart contract added to the blockchain network (e.g., to prevent automatic transfer of digital assets) based on instructions sent to the blockchain to revoke the smart contract from the blockchain. As described herein, a smart contract may execute according to its included computer code based on its rules and/or conditions being met. Smart contracts generated by the digital asset transfer system 100 may be used to execute automatic transfer of digital assets between a user (e.g., owner) and their configured beneficiary(ies) and/or backup wallet(s). In some embodiments, the digital asset transfer system 100 may generate smart contracts that are configured to cause transfer digital assets from a user's wallet(s) to beneficiary and/or backup wallet(s) based on an activity monitor (e.g., referred to herein as a “pulse checker” function). The smart contracts generated by the digital asset transfer system 100 may execute based on one or more fixed parameters and/or one or more variable parameters configured in the digital asset transfer system 100 as described further below.

In some embodiments, a smart contract generated by the digital asset transfer system 100 may interface with one or more other smart contracts generated by the digital asset transfer system 100. For example, as shown in FIG. 1, a proxy smart contract (SC) corresponding to a user that includes computer code to automatically transfer digital assets may interface and/or communicate with a business smart contract (SC) corresponding to an owner or administrator of the digital asset transfer system 100 (e.g., to provide and/or receive data to/from a blockchain oracle). The proxy smart contract may interface with a factory SC that is configured to provide input parameters for the proxy SC. The membership SC may track and record users (i.e. members) of the digital asset transfer system 100 on a blockchain network. The smart contracts included in the on-chain assets 160 (e.g., including the factory SC, proxy SC, membership SC, and business SC) are exemplary and additional or alternative smart contracts may be generated by the digital asset transfer system 100. In some cases, digital asset transfer system 100 may cause generation of one proxy smart contract per user, where the proxy smart contract is configured to transfer the user's digital assets from the user's wallet(s) to beneficiary wallet(s) as described herein.

In some embodiments, the pulse checker may be used to automatically transfer selected digitals assets from a user to their selected beneficiary wallet(s) and/or backup wallet(s). The pulse checker may be computer code (e.g., a computer program, computer script, etc.) configured to interface with and/or included in a smart contract on the blockchain network that can monitor activity of the user on a blockchain network. The pulse checker may monitor activity of the user (e.g., via the user's connected wallet(s)) on the blockchain network that comprises the pulse checker and corresponding smart contract. Based on a configured duration of inactivity (referred to as “inactivity duration”) as monitored by the pulse checker, the smart contract corresponding to (e.g., including) the pulse checker may execute to automatically transfer the user's configured digital assets to the respective beneficiary wallet(s) and/or backup wallet(s). The inactivity duration may be a predetermined duration or a duration selected by a user (e.g., via the user interface). As an example, the predetermined duration of inactivity may be 14 months (or any other suitable duration). The pulse checker may monitor for activity of the user on the blockchain network by monitoring the user's wallet for wallet activity. Some non-limiting examples of wallet activity can include the wallet signing a transaction, sending a transaction request to the blockchain network, sending tokens and/or cryptocurrency, assigning delegate wallet permissions, and/or any other wallet owner generated activity. Additionally or alternatively, other indicators of activity and/or inactivity of the user on the blockchain network may be used by the pulse checker. The pulse checker module may receive information from the on-chain pulse checker to determine a status of the smart contract. A status of the smart contract may include an indication of whether the smart contract was executed and/or when the smart contract is scheduled to execute (e.g., based on an inactivity duration).

In some embodiments, as described above, the digital asset transfer system 100 may automate digital asset transfer based on one or more fixed and/or variable parameters. The parameters may be selected using and/or included in the digital asset transfer system 100. Fixed parameters of the digital asset transfer system 100 may be parameters used for the generation of a smart contract to automate digital asset transfer and for management of the smart contract and digital assets (e.g., before or after transfer from a user to beneficiaries). Some non-limiting examples of fixed parameters include user wallet(s), beneficiary wallet(s), backup wallet(s), the pulse checker, user approval, beneficiary approval, an unclaimed digital asset wallet, a template proxy smart contract, a business smart contract, a membership smart contract, and pulse checker notifications. Variable parameters may be parameters that vary according to the configuration of the fixed parameters and/or parameters that are optionally selected. Some non-limiting examples of variable parameters include a number of beneficiary wallets, a number of backup wallets, a trust beneficiary, a supervising attorney corresponding to the user, signing a transaction to be added to the blockchain network, an inactivity duration for the pulse checker, and blockchain networks supported by the digital asset transfer system 100. Additional features of the fixed and/or variable parameters are described further below.

In some embodiments, based on approval from a user (e.g., provided to the user interface), the digital asset transfer system 100 may cause generation of a smart contract (e.g., via a dApp corresponding to the blockchain network) that automates transfer of digital assets between the user wallet(s) and their selected beneficiary wallet(s) and/or backup wallet(s). A dApp of the digital asset transfer system 100 may generate the smart contract based on user approval and may append the smart contract to a blockchain network. The smart contract may include indicators of the user's wallet(s), the digital asset(s) included in the user's wallet(s) configured to be transferred, the beneficiary wallet(s) for the digital assets, the backup wallet(s) for the digital assets, and the percentage and/or number of configured tokens to be transferred to respective beneficiary and/or backup wallet(s). The smart contract may include one or more computer code configured to cause the transfer of the digital assets. The smart contract may include a signature corresponding to public and/or private key's corresponding to the user's wallet(s). The one or more computer code may include the pulse checker with an inactivity duration, such that the pulse checker monitors for activity by the user's wallet(s) on the blockchain network as described herein. In other cases, the pulse checker may be included and/or added to the blockchain network and may be external to the smart contract. For example, the pulse checker may be included in the smart checker module of the off-chain components 110.

In some embodiments, the digital asset transfer system 100 may include one or more remote procedure calls (RPC) computing nodes. The RPC nodes may be part of the off-chain components 110 and may communicate with the on-chain components 160. Based on approval from a user (e.g., provided to the user interface), the digital asset transfer system 100 may send a communication to the RPC node indicative of parameters of a smart contract to be generated and added to the blockchain network, where the smart contract automates transfer of digital assets between the user wallet(s) and their selected beneficiary wallet(s) and/or backup wallet(s). The communication may include information indicating that the user has approved the smart contract to be generated and added to the blockchain pending a secondary approval. Secondary approval to cause generation and sending of the smart contract may be provided to the RPC node. Based on receiving the secondary approval to cause generation of the smart contract, the RPC node may communicate with on-chain components 160 to cause generation of the smart contract (e.g., via a dApp corresponding to the blockchain network) as described herein. A user may provide the secondary approval to the RPC node using one or more techniques. In some cases, a user may provide the secondary approval via a message (e.g., Short Message Service (SMS) message, email, etc.) sent to the RPC node. In some cases, the user may provide the secondary approval via the user interface of the digital asset transfer system 100. In some cases, the user may provide the secondary approval via an input provided to the RPC node via a user interface of the RPC node, where the user interface of the RPC node is accessible by a private uniform resource locator (URL).

In some embodiments, after the smart contract is added to the blockchain network, the smart contract may execute independently of the digital asset transfer system 100 (and the included dApp). The pulse checker included in the smart contract may continuously monitor for activity corresponding to the user's wallet(s) by identifying whether the wallet(s) have exhibited wallet activity as described herein within the inactivity duration. In some cases, the pulse checker may include and/or otherwise access an inactivity timer. The pulse checker may continuously monitor the inactivity timer to determine whether the inactivity duration has expired, such that any and/or all of the user's wallet(s) have been inactive (e.g., by not exhibiting wallet activity) for a threshold period of time. If the inactivity timer is not expired, the pulse checker may continue monitoring for wallet activity by the user. If the pulse checker identifies that the user's wallet(s) have signed a transaction and/or otherwise exhibited wallet activity within the inactivity duration (e.g., prior to the expiry of the inactivity timer), the pulse checker may reset the inactivity timer to the selected inactivity duration (e.g., 1 month, 6 months, 12 months, 14 months, etc.) and may continue monitoring for wallet activity by the user. For example, if the pulse checker identifies wallet activity when the inactivity timer is two months to expiration, the pulse checker may reset the inactivity timer to a 14 month inactivity duration and the inactivity timer may begin running. If the inactivity timer has expired, the pulse checker may identify that the user's wallet has been inactive for a threshold amount of time and the smart contract may execute to transfer the configured digital asset(s) from the user's wallet(s) to the beneficiary wallet(s) and/or backup wallet(s). In some cases, if the inactivity timer has expired, the smart contract may execute to transfer the configured digital assets from the user's wallet(s) to the beneficiary wallet(s) and/or backup wallet(s). In other cases, if the inactivity timer has expired, the smart contract may not execute to transfer the configured digital assets from the user's wallet(s) to the beneficiary wallet(s) and/or backup wallet(s) until the digital assets have been claimed by the respective beneficiary(ies) and/or user(s) as described below. For such embodiments, the smart contracts may receive an indication from off-chain (e.g., an input provided to the user interface of the digital asset transfer system 100) that a beneficiary and/or user has claimed their respective digital assets and may execute based on receiving such an indication.

In some embodiments, the digital asset transfer system 100 may generate and send one or more notifications to the user. The digital asset transfer system 100 may generate and send the notifications via a notification API (e.g., a SendGrid API as shown in FIG. 1). In other cases, the digital asset transfer system 100 may generate, send, and/or cause display of notifications based on an on-chain token (e.g., non-fungible token) configured to provide an indication of the status of the pulse checker. In some cases, the digital asset transfer system 100 may generate and send one or more notifications to the user based on a time remaining for the inactivity time. A status of the pulse checker may quantitatively and/or qualitatively (e.g., categorically) represent the time remaining on the inactivity timer before the pulse checker triggers automatic transfer of digital assets. In some cases, the notifications may provide an indication instructing a user to cause wallet activity to prevent the automatic transfer of digital assets by a smart contract included on the blockchain network. The notifications may be any one of email notifications, social media notifications, cellular (e.g., SMS) notifications, and/or any other suitable digital notifications used to contact a user. The digital asset transfer system 100 may send the notifications at one or more predetermined times based on the status of the inactivity timer, or based on one or more conditional triggers. As an example, a certain type of notification may only trigger (e.g., be generated and sent to a user) if the previous notification type has failed to result in a response from the user (e.g., in the form of wallet activity). For example, the digital asset transfer system 100 may send notifications at times of 1 month, 2 weeks, 1 week, 3 days, and 1 day remaining before the expiry of the inactivity timer. In some cases, conditional triggers that may cause the digital asset transfer system 100 may send a notification to a user can included an detected wallet activity and an identified security breach as described further below. Such a notification may enable a user to cause transfer of their digital assets (e.g., to a backup wallet) in response to potentially malicious activities with respect to the user's credentials of the digital asset transfer system.

In some embodiments, beneficiaries corresponding to the beneficiary wallet(s) and the user corresponding to the backup wallet(s) may be required to claim the transferred digital assets using the user interface of the digital asset transfer system 100. As described above, in some embodiments, the smart contract may execute based on an expiry of the inactivity timer, thereby causing transfer of configured digital assets from the user's wallet(s) to the beneficiary and/or backup wallet(s). In other embodiments, after the expiry of the inactivity timer, the smart contract may not execute to transfer digital assets from the user's wallet(s) until a beneficiary and/or a user (e.g., corresponding to backup wallet(s)) claims their respective digital assets. The digital assets configured to be transferred by the smart contract may remain in the user's wallet(s) until a beneficiary and/or a user claims their respective digital assets as described below.

In some embodiments, using the user interface, an individual may connect their respective wallet(s). Based on corresponding wallet address(es) of the connected wallet(s), the digital asset transfer system 100 may provide and/or display one or more notifications at the user interface. If the input wallet address(es) do not correspond to beneficiary and/or backup wallet address(es) included in a smart contract generated by the digital asset transfer system 100, the user interface may provide an indication that the input wallet address(es) are not configured as beneficiary and/or backup wallet address(es), such that individual is not a beneficiary corresponding to the user or the user themself. If the input wallet address(es) do correspond to beneficiary and/or backup wallet address(es) included in a smart contract generated by the digital asset transfer system 100 and the digital assets have not been transferred and/or configured to be transferred to the beneficiary and/or backup wallet address(es), the user interface may provide an indication that the input wallet address(es) is/are a beneficiary or a backup wallet and that the digital assets are not ready to be claimed. If the input wallet address(es) do correspond to beneficiary and/or backup wallet address(es) included in a smart contract generated by the digital asset transfer system 100 and the digital assets have been transferred or are configured to be transferred to the beneficiary wallet address(es) (e.g., due to execution of the smart contract and/or expiry of the inactivity timer), the user interface may provide an indication that the input wallet address(es) is/are a beneficiary or a backup and that the digital assets are ready to be claimed.

In some embodiments, the user interface may enable the beneficiary and/or the user themselves to claim one or more of the digital assets transferred or configured to be transferred to the beneficiary and/or back up wallet address(es) from the user. In some cases, the beneficiary and/or user may claim all of the digital assets transferred or configured to be transferred from the user's wallet(s), such that each of the digital assets configured by the user are transferred from the user's wallet(s) to the beneficiary's wallet(s) and/or backup wallet(s). In other cases, the beneficiary and/or the user themselves may claim a subset or none of the digital assets transferred or configured to be transferred from the user's wallet(s), such that a subset or none of the digital assets configured by the user are transferred from the user's wallet(s) to the beneficiary's wallet(s) and/or backup wallet(s). If any of the digital assets designated for the beneficiary and/or backup wallet(s) in the smart contract are not claimed by the beneficiary or the user, the unclaimed digital assets may be automatically transferred to an unclaimed digital asset wallet (referred to as a “pool wallet” in FIG. 1). In some cases, the unclaimed digital assets may be automatically transferred from the user's wallet(s) to the unclaimed digital asset wallet after a configured duration of time (e.g., after the expiration of the inactivity timer and/or based on trigger events configured for the smart contract) and/or based on the beneficiary(ies) or the user providing inputs to user interface to decline the digital assets. The unclaimed digital asset wallet may be a wallet address managed and/or otherwise owned by administrators or a community of members (e.g., a Decentralized Autonomous Organization (DAO)) with governance tokens that can manage parameters of the digital asset transfer system 100. In some cases, the digital asset transfer system 100 may be configured to distribute digital assets received at the unclaimed digital asset wallet to any or all of the users of the digital asset transfer system 100.

In some embodiments, the smart contract included in the blockchain network may be configured to automatically transfer digital assets in the event of a security breach corresponding to a user of the digital asset transfer system 100. A user may configure the transfer of selected digital assets to selected beneficiary and/or backup wallets in the event of the security breach using the user interface. A security breach may correspond to an unauthorized access of a user's credential for the digital asset transfer system 100. As an example, the digital asset transfer system 100 may identify a threshold number of attempts (e.g., incorrect password attempts) to access the digital asset transfer system 100 using a user's credential. As another example, there could be unrecognized transactions or approvals made on any of the user's wallets that could also indicate a security breach. Based on an identified security breach, the digital asset transfer system 100 may interface and/or communicate with the smart contract on the blockchain network to cause the smart contract to execute and transfer digital assets. The digital assets may be transferred from the user's wallet(s) to the beneficiary and/or backup wallet(s) as described above with respect to the execution of the smart contract based on the pulse checker. The smart contract executing to automatically transfer digital assets based on an identified security breach may be referred to as a “kill switch” or “panic button” function, such that digital assets are transferred in response to potentially malicious activities with respect to the user's credentials. In some cases, via an input provided at the user interface, a user may manually cause transfer of their digital assets to the selected beneficiary and/or backup wallet(s).

In some embodiments, the present system and methods may be adapted for one or more additional use cases. The digital asset transfer system 100 may generate one or more smart contracts to transfer digital assets between a user and a beneficiary according to one or more conditions. In some cases, a generated smart contract may not include a pulse checker and may include one or more computer code configured to executed based on configured condition(s). The generated smart contract may receive indications(s) of the configured condition(s) being met from one or more on-chain and/or off-chain data sources (e.g., via a blockchain oracle as shown in FIG. 1). The one or more conditions may include legal agreements such as divorce agreements, prenuptial agreements, commercial/corporate agreements, etc. Via the user interface of the digital asset transfer system 100, a user may configure conditions for a smart contract that result in the transfer of digital assets to beneficiary(ies) and/or backup wallets. In some cases, the digital asset transfer system 100 may include one or more dApps configured to generate such smart contracts and interface between the generated smart contracts and off-chain data sources.

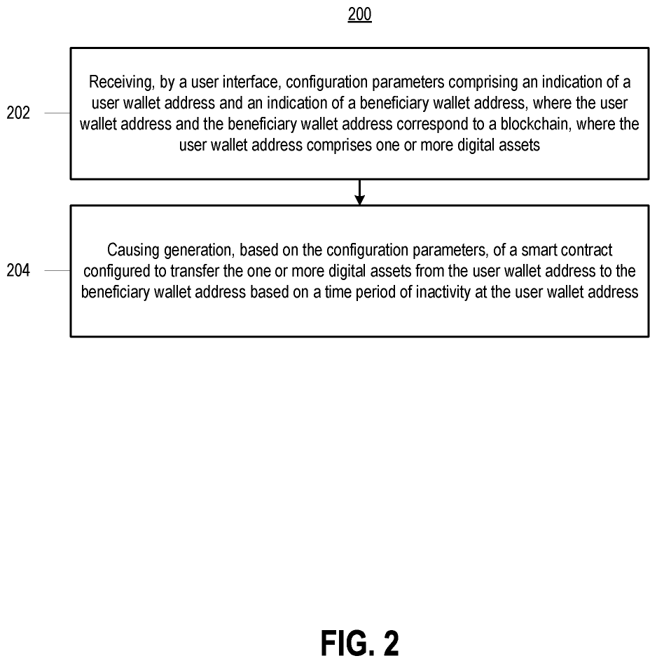

In some embodiments, the digital asset transfer system 100 may cause generation of smart contracts configured to automatically transfer digital assets between a sender (i.e. user) wallet address and a receiver (i.e. beneficiary) wallet address. To cause generation of one of the smart contracts, the digital asset transfer system 100 may perform a method for digital asset transfer. Referring to FIG. 2, a flowchart of an exemplary method 200 for digital asset transfer is depicted. The method 200 may be suitable for causing generation of a smart contract that is appended to a blockchain, where the smart contract is configured to execute based on one or more conditions. One of ordinary skill in the art will appreciate that the method 200 may be executed by the digital asset transfer system 100 more than once to cause generation of smart contracts for different users of the digital asset transfer system 100.

At step 202, the digital asset transfer system 100 may receive, by a user interface, configuration parameters comprising an indication of a user wallet address and an indication of a beneficiary wallet address. The configuration parameters may include public and/or private keys for the user wallet address (e.g., provided at the user interface. The user wallet address and the beneficiary wallet address may correspond to a blockchain and the user wallet address may include one or more digital assets. The digital assets may include a cryptocurrency token and/or a non-fungible token. In some cases, the digital asset transfer system 100 may receive, by a user interface, a first input configured to cause generation of the smart contract. In some cases, the digital asset transfer system 100 may send the configuration parameters to an RPC node. The RPC node may be configured to cause generation of the smart contract based on receiving a second approval input.

At step 204, the digital asset transfer system 100 may cause generation, based on the configuration parameters, of a smart contract configured to transfer the one or more digital assets from the user wallet address to the beneficiary wallet address. The smart contrast may be configured to transfer the digital assets based on a time period of inactivity at the user wallet address. To cause generation of the smart contract, the digital asset transfer system 100 may send, to a dApp operating on the blockchain, instructions to generate the smart contract. The instructions may include the configuration parameters. The dApp may be configured to (i) generate the smart contract; and (ii) send the smart contract to the blockchain. The smart contract may be configured to identify wallet activity at the user wallet address. The time period of inactivity at the user wallet address may be a duration for which the smart contract has not identified the wallet activity at the user wallet address. Wallet activity may include the wallet address signing a transaction, sending a transaction request to the blockchain, sending digital assets, and/or assigning delegate permission. Based on identifying wallet activity at the user wallet address, the smart contract may be configured to reset the tracked time period of inactivity to zero seconds. When the time period of inactivity at the user wallet address exceeds a threshold time period, the smart contract may be configured to transfer the one or more digital assets from the user wallet address to the beneficiary wallet address. In some cases, a third input including an indication to claim the one or more digital assets at the beneficiary wallet address must be received for the smart contract to transfer the one or more digital assets from the user wallet address to the beneficiary wallet address based on the indication. The digital asset transfer system 100 may send the indication to claim the assets to the smart contract to cause the transfer. In some cases, the digital asset transfer system may identify a security event associated with a user's credential to access the digital asset transfer system 100, where the smart contract may be configured to transfer the one or more digital assets from the user wallet address to the beneficiary wallet address based on the identification of the security event. In some cases, the user interface of the digital asset transfer system may receive an indication to revoke the smart contract and may send instruction to the blockchain (e.g., the dApp) to revoke the smart contract.

### Computer-Based Implementations

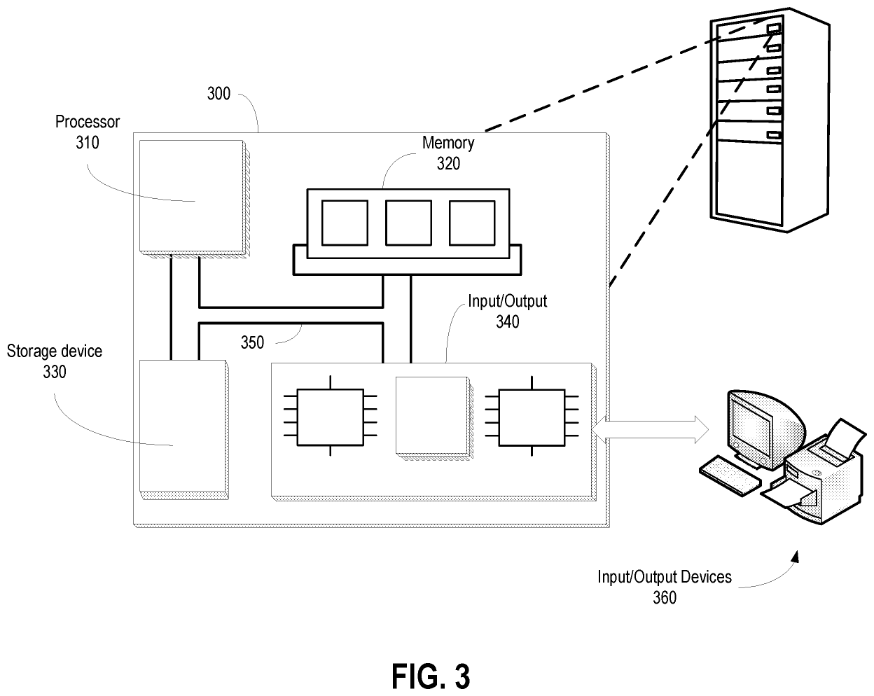

In some examples, some or all of the processing described above can be carried out on a personal computing device, on one or more centralized computing devices, or via cloud-based processing by one or more servers. In some examples, some types of processing occur on one device and other types of processing occur on another device. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used. An example computing system in which the subject matter as described herein may be executed or performed is shown in FIG. 3.

FIG. 3 is a block diagram of an example computer system 300 that may be used in implementing the technology described in this document. General-purpose computers, network appliances, mobile devices, or other electronic systems may also include at least portions of the system 300. The system 300 includes a processor 310, a memory 320, a storage device 330, and an input/output device 340. Each of the components 310, 320, 330, and 340 may be interconnected, for example, using a system bus 350. The processor 310 is capable of processing instructions for execution within the system 300. In some implementations, the processor 310 is a single-threaded processor. In some implementations, the processor 310 is a multi-threaded processor. The processor 310 is capable of processing instructions stored in the memory 320 or on the storage device 330.

The memory 320 stores information within the system 300. In some implementations, the memory 320 is a non-transitory computer-readable medium. In some implementations, the memory 320 is a volatile memory unit. In some implementations, the memory 320 is a nonvolatile memory unit.

The storage device 330 is capable of providing mass storage for the system 300. In some implementations, the storage device 330 is a non-transitory computer-readable medium. In various different implementations, the storage device 330 may include, for example, a hard disk device, an optical disk device, a solid-date drive, a flash drive, or some other large capacity storage device. For example, the storage device may store long-term data (e.g., database data, file system data, etc.). The input/output device 340 provides input/output operations for the system 300. In some implementations, the input/output device 340 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 360. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 330 may be implemented in a distributed way over a network, such as a server farm or a set of widely distributed servers, or may be implemented in a single computing device.

Although an example processing system has been described in FIG. 3, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

In some embodiments, the computer-based implementations described herein may be used in a blockchain. FIG. 4 is an exemplary system diagram illustrating a blockchain 400, according to some embodiments. With reference now to FIG. 4, a blockchain 400 includes a plurality of blocks 402. Each block 402 is a data structure that includes data representing transactions 404, for example, smart contracts, payment receipts, or any other transaction. Some non-limiting examples of the blockchain 400 include Tezos, Flow, Solana, Cardano, Binance Smart Chain, Ethereum, Polygon, WAX, and Cronos blockchain networks. The blockchain 400 may be any suitable blockchain network configured to support smart contracts. As described above, as new transactions 404 are submitted to the blockchain 400 and validated, additional blocks 402 are generated and appended to the blockchain 400. Each new block 402 also includes a hash 406 of the immediately previous block 402. For example, block 2 includes a hash of block 1, block n includes a hash of block n−1, etc.

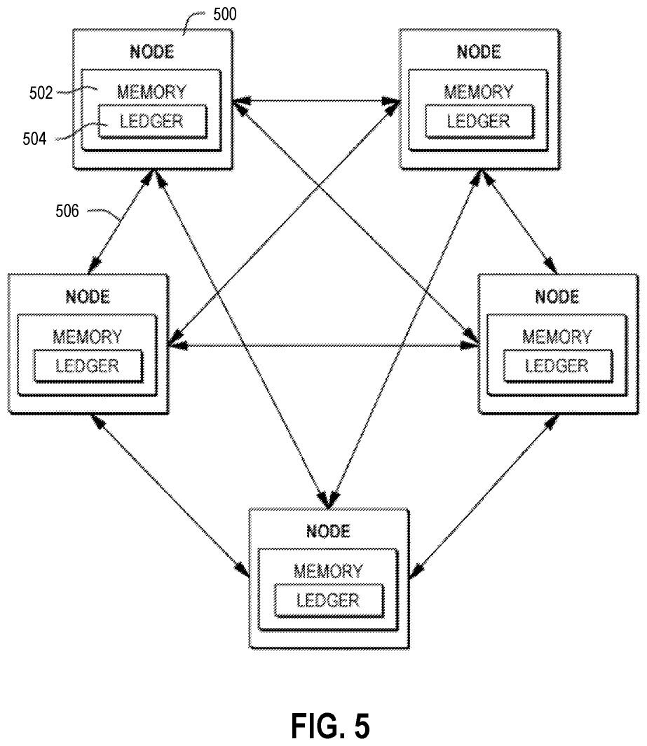

In some embodiments, the blockchain shown and described with respect to FIG. 4 may be associated with one or more nodes. FIG. 5 shows an exemplary system diagram of nodes associated with a blockchain (e.g., of FIG. 4) and storing the ledger of the blockchain, according to some embodiments. With reference now to FIG. 5, in some aspects, blockchain 400 is stored in a decentralized manner on a plurality of nodes 500, e.g., computing devices located in one or more networks. Nodes 500 may each include a memory 502 that stores at least a portion of a ledger 504 of blockchain 400. Ledger 504 includes any data blocks 402 that have been validated and added to the blockchain 400. In some aspects, every node 500 may store the entire ledger 504. In some aspects, each node 500 may store a portion of ledger 504. In some aspects, some or all of blockchain 400 may be stored in a centralized manner. Nodes 500 may communicate with one another via communication pathways 506, e.g., wired or wireless connections, over the internet, etc. to transmit and receive data related to ledger 504. For example, as new data blocks 402 are added to ledger 504, nodes 500 may communicate or share the new data blocks 402 via communication pathways 506.

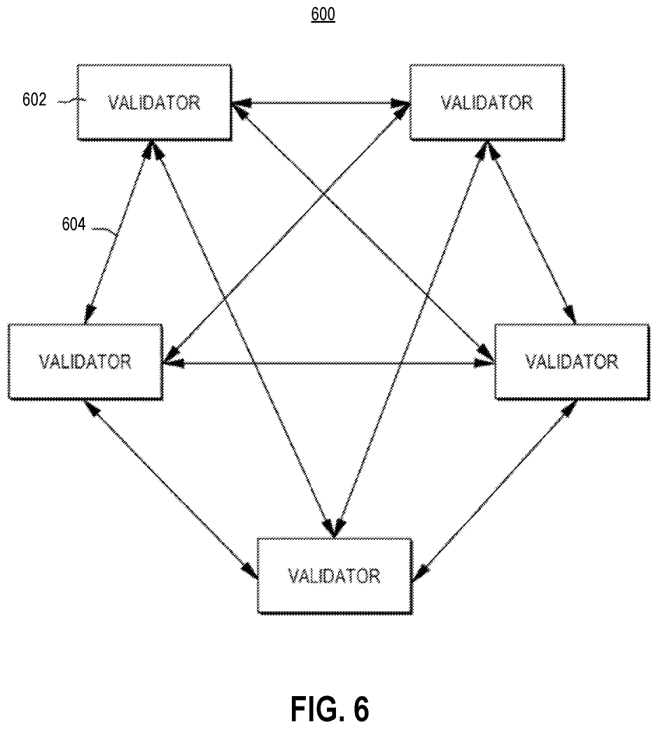

In some embodiments, one or more nodes storing a blockchain (e.g., as shown and described with respect to FIG. 5) may validate transactions submitted to the blockchain. FIG. 6 is an exemplary system diagram illustrating validator nodes associated with a blockchain (e.g., of FIG. 4), according to some embodiments. With reference now to FIG. 6, any transactions 404 submitted to blockchain 400 are validated by a set of validator nodes 600 associated with blockchain 400. For example, transactions 404 may be transmitted to one or more of the validator nodes 600 and may be shared between the validator nodes 600 for validation and consensus. Each validator node 602 determines whether a transaction 404 is valid and whether the transaction 404 complies with the rules of the blockchain 400. The validator node 602 adds a plurality of the validated transactions 404 to a data block 402 and submits the data block 402 for consensus by all or some of the other validator nodes. The other validator nodes 602 then vote “for” or “against” appending the data block 402 containing the transactions 404 to the blockchain 400. A consensus of the set of validator nodes 600, e.g., a threshold number of identical votes “for” or “against”, is required to allow or deny the data block 402 to be appended to the blockchain 400. In some aspects, one or more of nodes 500 may also be validator nodes 602. In some aspects, nodes 500 that are not validator nodes 602 may perform processing such as, for example, receiving transaction submissions, providing member services, delivering events to applications, handling application programming interface (API) requests from users, or other similar functions. In this manner, the processing power of the validator nodes 602 may be preserved for generating new blocks, reaching consensus, and monitoring the other validator nodes 602. Validator nodes 602 may communicate with one another via communication pathways 604, e.g., wired or wireless connections, over the internet, etc., to transmit and receive data. For example, as new data blocks 402 are generated by validator nodes 602, validator nodes 602 may communicate or share the new data blocks 402 and transmit and receive consensus messages via communication pathways 604.

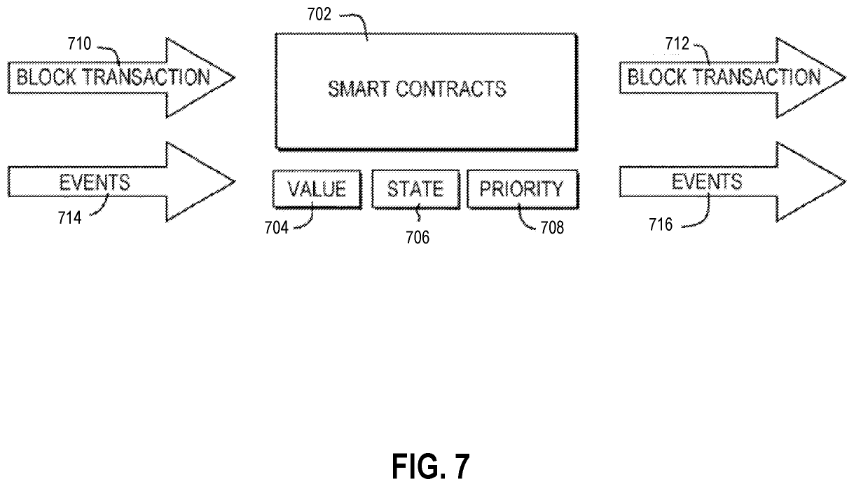

In some embodiments, as describe herein, smart contracts (e.g., that automatically transfer digital assets) may be submitted and added to a blockchain. FIG. 7 is a diagram illustrating an exemplary smart contract, according to some embodiments. With reference now to FIG. 7, an example smart contract 702 is illustrated including a value 704 (e.g., a numerical value, monetary value, or any other value), a state 706 of the smart contract (e.g., a number of items of a product sold in all retail outlets of a firm, or other similar information that may be dependent on other sources). In some aspects, smart contract 702 may receive value 704 from a transaction in a block 710, or aggregated from multiple transactions in a block 710, and the value 704 may be sent to another smart contract via a transaction 712. Smart contract 702 may also receive information about the state 706 from an event 714, or aggregated from multiple events 714, and the state 706 may be sent as an event 716 to another smart contract.

Priority level 708 may be compared to the priority level of other smart contracts or transactions to determine a hierarchy of smart contracts on the blockchain. For example, the priority level 708 may be checked against the priority level of other smart contracts or transactions to determine whether there are any higher priority smart contracts or transactions whose terms must be complied with by smart contract. The exemplary smart contract may include computer code configured to cause automatic transfer of digital assets as described herein. The computer code may include indications of any one of the fixed and/or variable parameters as described herein.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A computer-implemented method for digital asset transfer, the method comprising:
receiving, by a user interface, configuration parameters comprising an indication of a user wallet address and an indication of a beneficiary wallet address, wherein the user wallet address and the beneficiary wallet address correspond to a blockchain, wherein the user wallet address comprises one or more digital assets; and
causing generation, based on the configuration parameters, of a smart contract configured to transfer the one or more digital assets from the user wallet address to the beneficiary wallet address based on a time period of inactivity at the user wallet address.

2. The method of claim 1, wherein the digital assets comprise at least one of a cryptocurrency token and/or a non-fungible token.

3. The method of claim 1, further comprising:
receiving, by the user interface, a first input configured to cause generation of the smart contract.

4. The method of claim 1, wherein the causing generation of the smart contract further comprises:
sending, to a decentralized application operating on the blockchain, instructions to generate the smart contract, wherein the instructions comprise the configuration parameters, and wherein the decentralized application is configured to (i) generate the smart contract; and (ii) send the smart contract to the blockchain.

5. The method of claim 1, further comprising:
sending the configuration parameters to a remote procedure calls (RPC) node, wherein the RPC node is configured to cause generation of the smart contract based on receiving a second input.

6. The method of claim 1, wherein the smart contract is configured to identify wallet activity at the user wallet address and wherein the time period of inactivity at the user wallet address comprises a duration for which the smart contract has not identified the wallet activity at the user wallet address.

7. The method of claim 6, wherein the wallet activity comprises one or more of:
signing, by the user wallet address, a transaction;
sending, by the user wallet address a transaction request to the blockchain network;
sending, by user wallet address, digital assets; and
assigning, by the user wallet address, delegate permissions.

8. The method of claim 6, wherein based on identifying the wallet activity, the smart contract is configured to set the time period of inactivity to zero seconds.

9. The method of claim 1, wherein when the time period of inactivity at the user wallet address exceeds a threshold time period, the smart contract is configured to transfer the one or more digital assets from the user wallet address to the beneficiary wallet address.

10. The method of claim 1, further comprising:
receiving, by the user interface, a third input comprising an indication to claim the one or more digital assets at the beneficiary wallet address, wherein the smart contract is configured to transfer the one or more digital assets from the user wallet address to the beneficiary wallet address based on the indication.

11. The method of claim 1, further comprising:
identifying a security event associated with a credential for the user interface, wherein the credential is associated with the user wallet address, wherein the smart contract is configured to transfer the one or more digital assets from the user wallet address to the beneficiary wallet address based on the security event.

12. The method of claim 1, further comprising:
receiving, by the user interface, a fourth input comprising an indication to revoke the smart contract from the blockchain; and
sending, to the blockchain, second instructions to revoke the smart contract.

13. A system for providing a cyber resilience rating for an entity of a plurality of entities, the system comprising:
one or more computing systems programmed to perform operations comprising:
receiving, by a user interface, configuration parameters comprising an indication of a user wallet address and an indication of a beneficiary wallet address, wherein the user wallet address and the beneficiary wallet address correspond to a blockchain, wherein the user wallet address comprises one or more digital assets; and
causing generation, based on the configuration parameters, of a smart contract configured to transfer the one or more digital assets from the user wallet address to the beneficiary wallet address based on a time period of inactivity at the user wallet address.

14. The system of claim 13, wherein the operations further comprise:
receiving, by the user interface, a first input configured to cause generation of the smart contract.

15. The system of claim 13, wherein the causing generation of the smart contract further comprises:
sending, to a decentralized application operating on the blockchain, instructions to generate the smart contract, wherein the instructions comprise the configuration parameters, and wherein the decentralized application is configured to (i) generate the smart contract; and (ii) send the smart contract to the blockchain.

16. The system of claim 13, wherein the smart contract is configured to identify wallet activity at the user wallet address and wherein the time period of inactivity at the user wallet address comprises a duration for which the smart contract has not identified the wallet activity at the user wallet address.

17. The system of claim 16, wherein the wallet activity comprises one or more of:
signing, by the user wallet address, a transaction;
sending, by the user wallet address a transaction request to the blockchain network;
sending, by user wallet address, digital assets; and
assigning, by the user wallet address, delegate permissions.

18. The system of claim 13, wherein when the time period of inactivity at the user wallet address exceeds a threshold time period, the smart contract is configured to transfer the one or more digital assets from the user wallet address to the beneficiary wallet address.

19. The system of claim 13, wherein the operations further comprise:
receiving, by the user interface, a third input comprising an indication to claim the one or more digital assets at the beneficiary wallet address, wherein the smart contract is configured to transfer the one or more digital assets from the user wallet address to the beneficiary wallet address based on the indication.

20. The system of claim 13, wherein the operations further comprise:
identifying a security event associated with a credential for the user interface, wherein the credential is associated with the user wallet address, wherein the smart contract is configured to transfer the one or more digital assets from the user wallet address to the beneficiary wallet address based on the security event.
